(19) United States
(12) Patent Application Publication
(10) Pub. No.: US 2013/0156896 A1
(43) Pub. Date: Jun. 20, 2013

(54) CELLULOSE-BASED FOOD CASING HAVING A FUNGICIDAL FINISH AND A METHOD FOR PROTECTING CELLULOSE-BASED FOOD CASINGS FROM MOLD INFESTATION

(71) Applicant: CASETECH GMBH, Bomlitz (DE)

(72) Inventors: HEINRICH HENZE-WETHKAMP, WALSRODE (DE); ANTON KRALLMANN, BAD FALLINGBOSTEL (DE)

(73) Assignee: CASETECH GMBH, BOMLITZ (DE)

(21) Appl. No.: 13/712,120

(22) Filed: Dec. 12, 2012

(30) Foreign Application Priority Data
Dec. 14, 2011 (EP) 11193434.5

(51) Int. Cl. A22C 13/00; A23B 4/20

(52) U.S. Cl. CPC A22C 13/0013; A23B 4/20
USPC 426/105; 428/34.8; 514/569

(57) ABSTRACT

The present invention relates to tubular food casings based on cellulose having a fungicidal finish, and to a method for protecting such food casings from mold infestation.

### FIELD OF THE INVENTION

The present invention relates to tubular food casings based on cellulose having a fungicidal finish and to a method for protecting such food casings from mold infestation.

### BACKGROUND OF THE INVENTION

Cellulose casings stuffed with sausage have the drawback that, prior to stuffing and particularly after stuffing, i.e. during the ripening time of the raw sausages, they can be infested by unwanted mold fungus and other microorganisms. After infestation, the microorganisms can proliferate on the cellulose fibrous casing. With the growth of these microorganisms the quality of the sausage casing diminishes, as well as the quality of the stuffed sausage emulsion. The cellulose casing loses its stability by the infestation with microorganisms, and the sausages infested with mold are unmarketable, and therefore worthless.

The actual casing material consists of cellulose, namely cellulose hydrate, which is also referred to as regenerated cellulose or cellulose film. In its wall the cellulose layer preferably contains a fiber-reinforcement, for example of hemp fiber paper, which is covered with cellulose on one or both surfaces. These sausage casings, which are referred to as fibrous casing or cellulose fibrous casing are used for all casing sizes.

The food casing is produced in the traditional way, for example in the viscose process. In this process a tubular casing or a fibrous web, shaped to a tubular casing and made, for example, from paper or hemp fibers, is coated with an alkaline viscose solution on the inner and/or outer wall by a ring nozzle and treated with an acidic precipitation solution, which causes the cellulose to coagulate. If necessary, the viscose solution contains dye pigments required for forming a white or colored casing. For the production of unreinforced cellulose casings the viscose is directly extruded into the precipitation bath in a tubular shape. After drying and after completion, the received tubular casing of cellulose hydrate, which may be fiber reinforced, is finished on its outside with the coating according to the present invention.

In the literature several fungicidal compounds are known to perform these tasks. Such a method is disclosed in U.S. Pat. No. 4,867,204 (=DE-A 27 21 427). According to this method, the growth of microorganisms is prevented by a water-soluble anti-mycotic agent. The antimycotic agent is preferably propylene glycol, potassium, sodium or calcium propionate, potassium, sodium or calcium sorbate, propionic acid or a lower alkyl ester of p-hydroxybenzoic acid.

From DE-A 198 60 142 and DE-A 196 25 094 tubular films are known, which are sprayed with water and, if applicable, with a conventional fungicide, for example with a quaternary ammonium compound, and/or with a conventional preservative, preferably on both sides of the tubular films.

In EP-A 190 630 a possibly fiber reinforced food casing based on regenerated cellulose, cellulose ethers or other hydrophilic polymers is disclosed, which is pre-moistened with at least 40-45 weight percent water, ready to fill. To protect said casing from infestation with bacteria, mold fungi or other microorganisms it is treated with an antimycotically active agent. Preferably, the agent is a p-hydroxybenzoic acid alkyl ester.

A casing made from film-forming hydrophilic polymers, particularly from regenerated cellulose, is described in U.S. Pat. No. 3,864,499. In the polymers, oil-soluble additives are dispersed, in particular antioxidants, biocides, dyes, UV-absorbents, flavorings or odorants. Also disclosed is a cellulose sausage casing that contains an antimycotic agent which is permitted under food regulations. Preferably, the anti-mycotic agent is p-hydroxybenzoic acid methyl ester, ethyl ester or propyl ester.

### SUMMARY OF THE INVENTION

The aim of the invention is now to treat or finish cellulose-based tubular casings in such a way that, even after an infestation of the casings with mold fungi, the growth on the casings is securely prevented. Ideally, an impregnation or a coating with a respective antimycotically active substance is applied on the outside.

A further aim of the invention is that a treatment or a finish or an impregnation, applied from the outside, is overall stable against soaking. Since cellulose fibrous casings are soaked prior to stuffing, the impregnation must be provided in such a way that the fungicidal effect is still present without any considerable loss after the usual soaking time.

Surprisingly, it was found that carnosol, carnosic acid, rosemary oil, rosemary extracts, sage oil and sage extracts can effectively be used as fungicidally active ingredients for coating or impregnating cellulose-based food casings.

Thus, the above aim is achieved by a tubular cellulose-based food casing comprising a fungicidal coating or impregnation, characterized in that the coating or impregnation contains one or more substances from the group consisting of carnosol, carnosic acid, rosemary oil, rosemary extract, sage oil and sage extract as a fungicidally active ingredient.

### DETAILED DESCRIPTION OF THE PREFERRED EMBODIMENT

Carnosol and carnosic acid are constituents of rosemary and sage. Carnosic acid is employed as a fat-soluble antioxidant, as a preservative and as flavoring in foods like meat products, oils and fats, flour, powdered milk, fish products, sauces and fodder. In an expert assessment dating from June 2008 the European Food Safety Authority (EFSA) certified the safety of carnosic acid for use in food products. In the USA rosemary oil, which contains up to 30% carnosic acid, is classified as GRAS (Generally Reported As Safe) since 1965 (FEMA) and 1970 (FDA), respectively, and may be employed in food products.

Rosemary oil and sage oil are obtained, for example, by steam distillation of rosemary herb or sage herb, respectively. Rosemary extracts and sage extracts are obtained, for example, from rosemary herb or sage herb, respectively, by acetone extraction, by extraction with supercritical carbon dioxide, by ethanolic extraction or by a two-stage extraction with hexane and ethanol. Rosemary oil, rosemary extract, sage oil and sage extract in the sense of the present invention are all compositions that have been obtained from rosemary herb or sage herb, respectively, their leaves or any other parts, by using extraction processes, distillation processes or other digestion processes.

Tocopherols, butylated hydroxyanisole (BHA), butylated hydroxytoluene (BHT) and gallates are known as free radical scavenger and, therefore, as antioxidants. They are especially effective in a lipophilic environment.

Furthermore, in the course of the present invention, it was surprisingly found that the fungicidal effect of the coating or impregnation of the food casing can be increased disproportionately when the coating or impregnation additionally comprises one or more substances from the group consisting of tocopherols, butylated hydroxyanisole, butylated hydroxytoluene and gallates.

The fungicidally active coating or impregnation of the present invention preferably comprises an oily solvent. This solvent acts, in particular, as a solvent for the ingredients of the fungicidal composition the coating or impregnation is made with, and allows for an evenly distributed coating or impregnation, for example by finely spraying a respective composition. As solvents, triacylglycerols and paraffin oils are suitable, particularly those which are liquid under standard conditions. Preferably, paraffin oil is employed.

In a preferred embodiment of the invention the coating or impregnation of the food casing comprises a) carnosol and/or carnosic acid, and b) butylated hydroxyanisole and/or butylated hydroxytoluene. Therefore, in the scope of the present invention, coatings or impregnations are particularly preferred that, for example, contain carnosol and butylated hydroxyanisole; or carnosol and butylated hydroxytoluene; or carnosic acid and butylated hydroxyanisole; or carnosic acid and butylated hydroxytoluene; or carnosol, carnosic acid and butylated hydroxyanisole; or carnosol, carnosic acid and butylated hydroxytoluene. It is most preferable when the coating or impregnation contains carnosic acid and butylated hydroxyanisole.

With respect to the amounts of the active ingredients in the coatings or impregnations of the cellulose-based food casings according to the invention it was found that the percentage of the one or more substances from the group consisting of carnosol, carnosic acid, rosemary oil, rosemary extract, sage oil and sage extract is preferably 0.01 to 3.5 weight percent, particularly 0.02 to 0.7 weight percent, more preferably 0.03 to 0.20 weight percent, most preferably 0.04 to 0.15 weight percent, based on the dry food casing. A “dry cellulose-based food casing” still contains 5 to 10 weight percent of residual moisture (water), measured at 23° C. and 65% of relative humidity (RH). In any case, the amount ranges mentioned above also apply to the overall percentage of carnosol, carnosic acid, rosemary oil, rosemary extract, sage oil and sage extract in coatings or impregnations of the food casings according to the invention.

The percentage of said one or more substances from the group consisting of tocopherols, butylated hydroxyanisole, butylated hydroxytoluene and gallates is preferably 0.01 to 3.5 weight percent, particularly 0.02 to 0.7 weight percent, more preferably 0.03 to 0.20 weight percent and most preferably 0.04 to 0.15 weight percent, based on the dry food casing. The ranges mentioned above also apply to the overall percentage of tocopherols, butylated hydroxyanisole, butylated hydroxytoluene and gallates in coatings or impregnations of the food casings according to the invention.

With respect to the proportion of said two substance groups to each other it was found that the percentage in weight percent, based on the dry food casing, of said one or more substances from the group consisting of tocopherols, butylated hydroxyanisole, butylated hydroxytoluene and gallates in proportion to the percentage in weight percent, based on the dry food casing, of said one or more substances from the group consisting of carnosol, carnosic acid, rosemary oil, rosemary extract, sage oil and sage extract preferably lies between 1:10 and 10:1, particularly between 1:5 and 5:1 and more preferably between 1:2 and 2:1. The proportions mentioned above also apply to the overall proportion of tocopherols, butylated hydroxyanisole, butylated hydroxytoluene and gallates to carnosol, carnosic acid, rosemary oil, rosemary extracts, sage oil and sage extracts in coatings or impregnations of the food casings according to the invention.

Food casings in the sense of the invention are all cellulose-based food casings, particularly those made from cellulose casings, from cellulose fibrous casings or from cellulose-based textile casings.

Particularly preferred are those food casings according to the invention where the coating or impregnation is applied onto the food casing from the outside.

The food casings according to the invention can also be provided in a ruffled form. It became apparent that the fungicidal effectiveness of the coatings or impregnations according to the invention remains preserved when the ruffled casings are stuffed with sausage emulsion and thereby become unruffled.

Sausages comprising a food casing according to the invention as described above and that are filled with sausage emulsion are per se also objects of the present invention.

A further object of the present invention is a method for protecting tubular cellulose-based food casings from infestation with mold, wherein the food casing comprises a fungicidal coating or impregnation, characterized in that the coating or impregnation comprises one or more substances from the group consisting of carnosol, carnosic acid, rosemary oil, rosemary extract, sage oil and sage extract as a fungicidally active ingredient.

As described above it is particularly advantageous when, in said method, the coating or impregnation additionally comprises one or more substances from the group consisting of tocopherols, butylated hydroxyanisole, butylated hydroxytoluene and gallates.

The use of a food casing having a fungicidal coating or impregnation as described above is also envisaged in the other elaborations of the method according to the invention, wherein the coating or impregnation comprises, for example, an oily solvent, preferably paraffin oil.

The application of the coating or impregnation can be carried out in the usual ways. Normally, the food casing is rewound by a rewinding machine as a continuous web and, while rewinding, the food casing is finished on both sides with a coating or impregnation. The coating or impregnation can, for example, be carried out by conducting the food casing through a fluidized bath or by applying the coating or impregnation agent by spraying. Furthermore, it can be applied by rollers, similar to a printing process. It is particularly effective when the coating or impregnation agent is applied finely dispersed onto the surface of the food casing. Here, spraying through fine nozzles or dispersal by ultrasonic conditioning is appropriate. In the spraying method, the fine dispersal is achieved by nozzles working at a high pressure, where the finely dispersed droplets are accelerated to very high speeds. With the aid of an ultrasound system small droplet sizes can be generated, with the effect that an even better distribution can be achieved on the food casing.

The carnosic acid products proved to be particularly efficient, like, for example, the one by Aquanova sold under the name Pro Extract 150. It is known that carnosic acid is employed as fat-soluble antioxidant, as preservative and as flavoring agent in food products, like meat products, oils and fats, flour, powdered milk, fish products, sauces and fodder. Besides its antioxidant effect, carnosic acid also shows antimicrobial activity, for example against Staphylococcus aureus. This is thought to be caused by inhibition of nucleic acid synthesis in bacteria. In animal testing carnosic acid also showed a chemoprotective effect against carcinogens. Furthermore, butylated hydroxyanisole (BHA) was tested as an antioxidant. BHA effectively counteracts alterations caused by oxygen on fats, dyes and flavorings. From the literature it is known that BHA, besides good effects on fats, dyes and flavorings, at the same time shows a relatively weak activity against microorganisms.

BHA, for example, can be purchased from Eastman under the brand name Tenox. The company gives recommendations for usage with food products (sausages, snack food etc.) and also with packaging (as an additive for wax coatings used for food product packaging).

Tenox is very well mixable with paraffin oil, for example, and the food grade paraffin oil is required as a shirring lubricant in converting cellulose-based food casings to shirred sticks.

Surprisingly, for a fungicidal treatment carnosol, carnosic acid, rosemary oil, rosemary extract, sage oil and sage extract can also be applied to packaging materials and to non-edible food wrappings like cellulose fibrous casings.

In the spraying method, carnosol, carnosic acid, rosemary oil, rosemary extract, sage oil and/or sage extract can preferably be diluted with paraffin oil, together with, for example, polysorbate, alcohol and water. The concentration of the active ingredient in the oily coating liquid can all in all be 2 to 70 weight percent, preferably 3 to 20, particularly 4 to 7 weight percent. The solution is sprayed via 1 or 2 or more fluid nozzles at a fluid pressure of approx. 2 to 6 bar and with a nozzle size of, for example, 0.5 mm. The flow rate is adjusted in such a way that, in the shirring process, the cellulose-based food casing receives approx. 0.5 to 5%, particularly an amount of 2 to 3.5%, with respect to the dry casing. For a good dispersal of the active ingredient the droplet size that is achieved in the spraying process is crucial. The finer the droplet size can be adjusted in the spraying process, the denser the droplets will lie on the surface of the cellulose-based food casing. With decreasing distance the effectiveness against unwanted formation of mold increases. The best results are obtained at a droplet size of approx. 20 to 50 μm.

Carnosol and carnosic acid can qualitatively and quantitatively be detected with the aid of the HPLC method, described by Okamura N., Fujimoto Y., Kuwabara S., Yagi A. in “High-performance liquid chromatographic determination of carnosic acid and carnosol in Rosmarinus officinalis and Salvia officinalis”, 1994, J. Chromatogr A697:381-386. In this way, the concentration of carnosol and/or carnosic acid on the food casing after application can reliably be determined. In an analog manner, rosemary oil, rosemary extract, sage oil and sage extract can be detected.

The addition of known preservatives like potassium sorbate or sodium sorbate, together with a pH, slightly lowered to approx. 3-3.5, has proven reasonable. The pH can be lowered, for example, by adding citric acid.

It is still a further object of the present invention to use one or more substances from the group consisting of carnosol, carnosic acid, rosemary oil, rosemary extract, sage oil and sage extract for a fungicidal treatment of a food casing or of sausage products.

In a preferred embodiment of the invention said use is characterized by employing one or more substances from the group consisting of carnosol, carnosic acid, rosemary oil, rosemary extract, sage oil and sage extract as an ingredient of a fungicidal coating or impregnation of a food casing, or of a fungicidal coating or impregnation of sausage products.

An independent claim is included for a use of one or more substances from the group consisting of carnosol, carnosic acid, rosemary oil, rosemary extract, sage oil and sage extract as an ingredient of a coating or impregnation of a food casing, or as an ingredient of a coating or impregnation of sausage products.

In this connection, it is preferred that the food casing is a cellulose-based food casing, particularly a tubular cellulose-based food casing, further preferred a cellulose-based sausage casing.

The invention is further elucidated by the following examples.

### EXAMPLES

### Example 1

### Mixture of Carnosic Acid and Paraffin Oil

A cellulose fibrous casing Walsroder FR 60 in a flat state is sprayed on both of its outsides with a solution of
a. 20 weight percent NovoSol-PSP by Aquanova Darmstadt (with 30% carnosic acid in the mixture),
b. 80 weight percent paraffin oil by CG-Chemikalien under the name “Paraffinöl, perliquidum-dünnflüssig Ph.Eur. USP, FDA”
   during the shirring process in an inflated state, with a total amount of 3 weight percent, based on the dry casing.

### Example 2

### Mixture of Carnosic Acid and Tenox with Paraffin Oil

A cellulose fibrous casing Walsroder FR 60 in a flat state is sprayed on both of its outsides with a solution of
c. 10 weight percent Novosol-PSP by Aquanova Darmstadt (with 30% carnosic acid in the mixture)
d. 10 weight percent Tenox 4b by Eastman (with 20% BHA in the mixture), and
e. 80 weight percent paraffin oil, as in example 1, during the shirring process in an inflated state with a total amount of 3%, based on the dry casing.

### Comparative Example 1

During the shirring process, the cellulose fibrous casing mentioned in example 1 is sprayed with a mixture of
a. 30 weight percent Tenox 4b by Eastman (with 20% butylated hydroxyanisole in the mixture) and
b. 70 weight percent paraffin oil, as in example 1,
   during the shirring process in an inflated state with a total amount of 3 weight percent, based on the dry casing.

### Comparative Example 2

During the shirring process, the cellulose fibrous casing mentioned in example 1 is sprayed with a mixture of
c. 3 weight percent potassium sorbate by CG-Chemikalien, sold under the name “Kaliumsorbat FCC IV E 202”
d. 97 weight percent drinking water
in an inflated state with a total amount of 15 weight percent, based on the dry casing.

The specimens mentioned above were stuffed with raw sausage meat before and after soaking. In the soaking process the tubular casing is submerged for 30 minutes in warm running water. The stuffed sausages are dipped halfway into a mold solution consisting of 99.7 weight percent water and 0.3 weight percent M-EK-72 Mold by Chr. Hansen. Under this designation a strongly growing, whitish looking type of mold fungus called Penicilium nalgiovense is sold. The upper half of the stuffed sausage does not get in touch with the aqueous mold solution. After withdrawal from the mold solution the sausages are stored in a ripening chamber. In regular time intervals, for example after 2, 4 and 8 days, the stuffed sausages are examined for the formation of mold.

### Testing Procedure

The specimens mentioned above were stuffed with raw sausage meat before and after soaking. In the soaking process the tubular casing is dipped into warm running water for a time period of 30 minutes. Due to the soaking process the casing absorbs water and becomes much more flexible. With the higher flexibility the casing can be stuffed to a higher diameter, and there are less rejects when clipping the casings.

### Criteria of Evaluation

### 1. Growth of the Mold Spores

If the mold spores completely cover the surface of the casing after a minimum waiting time of 4 days the mark “6” will be assigned. If there is no growth at all the mark “1” will be assigned.

TABLE 1
Evaluation of Mold Growth

| | | Amount of | | | | |
|---|---|---|---|---|---|---|
| Casing Type | Amount of | Butylated | Amount of | | Mold | Mold |
| Walsroder FR | Carnosic | Hydroxy- | Potassium | Soaking prior | Suppression | Suppression |
| 60 | Acid | anisole⁽¹⁾ | Sorbate⁽¹⁾ | to Filling | after 4 Days | after 8 Days |
| Example 1 A | 0.18 | | | Yes | 1 | 1.5 |
| Example 1 B | 0.18 | | | No | 1 | 1 |
| Example 2 A | 0.09 | 0.06 | | Yes | 1 | 1.5 |
| Example 2 B | 0.09 | 0.06 | | No | 1 | 1 |
| Comparative | | 0.24 | | Yes | 2.5 | 5.5 |
| Ex. 1A | | | | | | |
| Comparative | | 0.24 | | No | 1.5 | 5 |
| Ex. 1B | | | | | | |
| Comparative | | | 0.45 | Yes | 3.5 | 5 |
| Ex. 2A | | | | | | |
| Comparative | | | 0.45 | No | 1.5 | 4 |
| Ex. 2B | | | | | | |

⁽¹⁾in weight percent, based on the weight of the dry casing

What is claimed is:

1. A tubular cellulose-based food casing comprising a fungicidal coating or impregnation, wherein the coating or impregnation comprises one or more substances selected from the group consisting of carnosol, carnosic acid, rosemary oil, rosemary extract, sage oil and sage extract as a fungicidally active ingredient.

2. The food casing according to claim 1, wherein said coating or impregnation additionally comprises one or more substances selected from the group consisting of tocopherols, butylated hydroxyanisole, butylated hydroxytoluene and gallates.

3. The food casing according to claim 1, wherein said coating or impregnation comprises an oily solvent.

4. The food casing according to claim 3, wherein said oily solvent is paraffin oil.

5. The food casing according to claim 1, wherein said coating or impregnation comprises a) carnosol and/or carnosic acid, and b) butylated hydroxyanisole and/or butylated hydroxytoluene.

6. The food casing according to claim 1, wherein said coating or impregnation is applied onto the food casing from the outside.

7. The food casing according to claim 1, wherein the percentage of the one or more substances selected from the group consisting of carnosol, carnosic acid, rosemary oil, rosemary extract, sage oil and sage extract is 0.01 to 3.5 weight percent, based on the dry food casing.

8. The food casing according to claim 7, wherein the percentage of the one of more substances is 0.02 to 0.7 weight percent based on the dry food casing.

9. The food casing according to claim 7, wherein the percentage of the one of more substances is 0.03 to 0.2 weight percent based on the dry food casing.

10. The food casing according to claim 7, wherein the percentage of the one of more substances is 0.04 to 0.15 weight percent based on the dry food casing.

11. The food casing according to claim 2, wherein the percentage of the one or more substances selected from the group consisting of tocopherols, butylated hydroxyanisole, butylated hydroxytoluene and gallates is 0.01 to 3.5 weight percent, based on the dry food casing.

12. The food casing according to claim 11, wherein the percentage of the one or more substances selected from the group consisting of tocopherols, butylated hydroxyanisole, butylated hydroxytoluene and gallates is 0.02 to 0.7 weight percent based on the dry food casing.

13. The food casing according to claim 11, wherein the percentage of the one or more substances selected from the group consisting of tocopherols, butylated hydroxyanisole, butylated hydroxytoluene and gallates is 0.03 to 0.20 weight percent based on the dry food casing.

14. The food casing according to claim 11, wherein the percentage of the one or more substances selected from the group consisting of tocopherols, butylated hydroxyanisole, butylated hydroxytoluene and gallates is 0.04 to 0.15 weight percent based on the dry food casing.

15. The food casing according to claim 1, wherein the percentage in weight percent, based on the dry food casing, of the one or more substances selected from the group consisting of tocopherols, butylated hydroxyanisole, butylated hydroxytoluene and the gallates in proportion to the percentage in weight percent, based on the dry food casing, of the one or more substances selected from the group consisting of carnosol, carnosic acid, rosemary oil, rosemary extract, sage oil and sage extract lies between 1:10 and 10:1.

16. The food casing according to claim 15, wherein the percentage in weight percent, based on the dry food casing, of the one or more substances selected from the group consisting of tocopherols, butylated hydroxyanisole, butylated hydroxytoluene and the gallates in proportion to the percentage in weight percent, based on the dry food casing, of the one or more substances selected from the group consisting of carnosol, carnosic acid, rosemary oil, rosemary extract, sage oil and sage extract lies between 1:5 and 5:1.

17. The food casing according to claim 15, wherein the percentage in weight percent, based on the dry food casing, of the one or more substances selected from the group consisting of tocopherols, butylated hydroxyanisole, butylated hydroxytoluene and the gallates in proportion to the percentage in weight percent, based on the dry food casing, of the one or more substances selected from the group consisting of carnosol, carnosic acid, rosemary oil, rosemary extract, sage oil and sage extract lies between 1:2 and 2:1.

18. The food casing according to claim 1, wherein said coating or impregnation additionally comprises potassium sorbate and/or sodium sorbate and/or has a pH of 3 to 3.5.

19. The food casing according to claim 1, wherein said food casing is provided in a shirred form.

20. A sausage, comprising a food casing according to claim 1, and a sausage emulsion enclosed by said food casing.

21. A method for protecting a food casing or a sausage product from mold infestation comprising coating or impregnating said food casing or said sausage product with one or more substances selected from the group consisting of carnosol, carnosic acid, rosemary oil, rosemary extract, sage oil and sage extract as a fungicidally active ingredient.

22. The method according to claim 21, wherein said one or more substances additionally comprises one or more substances selected from the group consisting of tocopherols, butylated hydroxyanisole, butylated hydroxytoluene and gallates.

23. The method according to claim 21, wherein said food casing is a cellulose-based food casing.

24. The method according to claim 23, wherein the cellulose-based food casing is a tubular cellulose-based food casing.

25. The method according to claim 23, wherein the cellulose-based food casing is a cellulose-based sausage casing.
